(19) United States
(12) Patent Application Publication
(10) Pub. No.: US 2013/0148748 A1
(43) Pub. Date: Jun. 13, 2013

(54) METHOD TO IDENTIFY TRACTOR AND TRAILERS AND THE ORDER OF HOOK UP

(71) Applicant: Raymond A. Suda, Sterling Heights, MI (US)

(72) Inventor: Raymond A. Suda, Sterling Heights, MI (US)

(21) Appl. No.: 13/709,669

(22) Filed: Dec. 10, 2012

Related U.S. Application Data
(60) Provisional application No. 61/568,837, filed on Dec. 9, 2011.
(60) Provisional application No. 61/672,432, filed on Jul. 17, 2012.

(51) Int. Cl. H04B 3/54

(52) U.S. Cl. CPC H04B 3/546
USPC 375/257

(57) ABSTRACT

Methods for connected tractor and trailer identifications and the order of hook-up of multiple trailers to a tractor enable the tractor and trailer identification and the order of trailer hook-up to be remotely broadcast from the tractor or trailers. In one aspect, the detection of vehicle identification and the order of trailer hook-up are determined by PLC tags mounted in the trailers or by a PLC Gateway mounted in the tractor or one of the trailers utilizing the PLC system on the tractor/trailers. In another aspect, the vehicle identifications are extracted from electronic modules existing on the tractor and trailers and sent to the PLC Gateway for broadcast from tractor/trailer.op

### CROSS REFERENCE TO CO-PENDING APPLICATIONS

This application claims priority benefit to the filing date of co-pending U.S. Provisional Patent Application Ser. No. 61/568,837 filed on Dec. 9, 2011 in the name of Raymond A. Suda, and entitled “Method to Identify Trailers and The Order in Which They Are Hooked Up”, and co-pending U.S. Provisional Patent Application Ser. No. 61/672,432 filed on Jul. 17, 2012 in the name of Raymond A. Suda, and entitled “Method to Identify Trailers and The Order In Which They Are Hooked Up,” the contents of both of which are incorporated herein in their entirety.

### BACKGROUND

The present description relates, in general, to tractor-trailer communication system.

The freight industry employs tractors which move one or more tandem or serially connected trailers between various locations. A standard seven conductor umbilical cord is coupled between the tractor and the first trailer, and between each pair of trailers to provide electrical power from controls in the tractor to the trailer brake lights, turn signals etc. However, the increased use of electronic modules on the trailer requires additional data communication conductors to avoid the expense of a separate umbilical cord to control such electronic modules, such as an ABS controller, an air tire pressure controller, or a refer temperature controller on the trailers. Power line carrier systems have been devised which provide data signals over one of the umbilical cord conductors to communicate information bidirectionally between the tractor and each trailer via power line carrier readers or gateways.

Today's freight companies transport goods over wide geographic locations. This widespread geographic area coupled with the trend for adjusting time deliveries as well as overnight deliveries, has necessitated a need for a freight company to know where each tractor and trailer is at any given time so as to coordinate delivery schedules, change routing etc.

Tractor communication systems have been devised along with GPS systems on the tractor and/or trailers, to provide remote communications which enables a central office of a freight company to immediately identify the geographic location of a specific tractor or trailer.

However, while such systems allow a freight company to determine the identification entity location of any trailer or tractor in its system at any given time, it has not yet been possible to determine the specific order that multiple trailers are connected in tandem to a particular tractor. This is important for scheduling and deliveries in a time efficient manner.

The electronic identification of particular tractor or trailer identification has required the use of specific power line carrier modules which can be programmed with a particular tractor or trailer identification number on which they are mounted. This is added cost to the power line carrier system.

PLC identifier tags, such as a PLC identifier tag manufactured by Hegemon Electronics, Inc., Sterling Heights, Mich., have been available since at least as early as 2005. Such PLC identifier tags, when installed on a tractor or trailer, send out a unique programmable identification number at regular intervals onto the vehicle PLC power line. This periodic vehicle identification transmission is detected by a PLC Gateway mounted in the tractor or trailer and used to detect the connection and disconnection of a trailer to and from a tractor. The detection of a connection or disconnection event is then transmitted by the PLC Gateway to a remotely located processor.

It would be desirable to provide improvements in tractor-trailer communication and identification systems using a power line carrier system.

### SUMMARY

A method to identify a plurality of trailers, each having unique trailer identification, and the order of hook up of the trailers sequentially coupled to a tractor. Each of the plurality of trailers and the tractor are in data communication via a power line carrier system, the method identifies the trailer identification in the order of coupling of each trailer to the tractor using, in part, the power line carrier system.

A power line carrier system including at least one power conductor is coupled between a tractor and each of the plurality of trailers for communicating data signals between the tractor and each of the plurality of trailers.

Identifying the trailer identification providing unique power line carrier identification in each of the tractors and the plurality of trailers.

The step of providing the PLC identification includes providing an identification tag on each trailer configured to broadcast unique trailer identification from each trailer to the power line carrier system.

The method further includes providing a wireless transmitter on each of the tractor and the plurality of trailers, each transmitter transmitting a message containing a unique wireless identification and an indication whether the vehicle is a tractor or one of the plurality of trailers, providing a wireless transmitter on each of the plurality of trailers coupled to the power line carrier system through the identification tag, the wireless receiver communicating the identification from the tractor and the plurality of trailers to the power line carrier system via the identification tag.

A method to identify the order of a plurality of trailers serially coupled to a tractor coupling includes a power line carrier system including at least one power conductor coupled between a tractor and each of the plurality of trailers for communicating data signals over the at least one power conductor between the tractor and each of the plurality of trailers, coupling a power line carrier gateway in one of the tractor and one of the plurality of trailers to the power line carrier system, mounting a wireless transmitter in the tractor, mounting a wireless receiver and a wireless transmitter in each of the plurality of trailers, providing a unique trailer identification on the trailer and on each of the plurality of trailers, transmitting by the power line carrier gateway a message on the power line carrier system containing information identifying the tractor and including the tractor identification, receiving by the wireless receiver on each of the plurality of trailers the message from the power line carrier gateway, transmitting by the wireless transmitter on each of the plurality of trailers the trailer identification to all of the trailers and the tractor within a signal range of each respective transmitter, determining a match by the PLC gateway between the tractor identification and the tractor identification received by only one of the plurality of trailers to identify the first trailer coupled to the tractor, transmitting by the first identified trailer a message on the power line carrier system that it is the first trailer coupled to the tractor, and receiving by each of the remaining plurality of trailers the message from the first trailer, and comparing the identification of the first trailer with the identification received by the wireless receiver on each trailer and determining a match, the match identifying the second trailer immediately coupled to the first trailer.

In one aspect, each tractor and trailer identification is stored in a readable power line carrier tag mounted respectively on each tractor and trailer and coupled to the power line carrier system.

In one aspect, the method includes the step of wirelessly transmitting by the trailers each identification on the power line carrier system, receiving the trailer identification by the power line carrier data terminal, receiving by each wireless receiver on each trailer all of the wireless identifications broadcast by the transmitters on all other of the plurality of trailers, transmitting by each trailer all of the trailer identifications onto the power line carrier system, receiving by the power line carrier gateway all of the trailer identifications and determining a match with the identifications received from the initial trailer identification broadcast, the power line carrier gateway comparing the trailer identification data to determine the trailer identification that reported the tractor identification, and for each remaining one of the plurality of trailers, the PLC gateway determining a match between the power line carrier tag on trailer which read the trailer identification from the proceeding trailer.

A method to identify the tractor and one or more trailers serially coupled to the tractor includes a power line carrier system coupled to at least one power conductor coupled between a tractor and each of the plurality of trailers for communicating data signals over the at least one power conductor between the tractor and each of the plurality of trailers, a power line carrier gateway mounted in one of the tractor and one of the plurality of trailers and coupled to the power line carrier system, a readable vehicle identification is stored in an electronic module in each of the tractor and the trailers. The power line carrier gateway extracts the vehicle identification from each of the tractor and the trailer electronic modules.

According to one aspect, the power line carrier gateway is mounted in one of the plurality of trailers and extracts the vehicle identification from the tractor via the power line carrier system to identify the particular tractor coupled to the trailer carrying the power line carrier gateway.

In the method each transmitter on each of the trailers has an effective transmission range to reach only a distance to a front portion of the next adjacent serially connected trailer to receive a message transmitted from the transmitter.

According to the method the electronic module mounted on each trailer and each of the plurality of tractors includes one of an ABS controller, a tire air pressure apparatus and a trailer temperature controller.

### BRIEF DESCRIPTION OF THE DRAWING

The various features, advantages and other uses of the present apparatus and method will become more apparent by referring to the following detailed description and drawing in which:

FIG. 1 is a block diagram of one aspect of the tractor-trailer identification and order of hook-up apparatus;

FIG. 2 is a detailed block diagram of the PLC tag and wireless RX shown in FIG. 1;

FIG. 3 is a block diagram of another aspect of the tractor-trailer identification and order hook-up apparatus and method;

FIG. 4 is a block diagram of another aspect of the tractor-trailer identification and order hook-up apparatus and method;

FIG. 5 is a block diagram of a tractor-trailer identification apparatus;

FIG. 6 is a block diagram showing a modification to the apparatus and method depicted in FIG. 4;

FIG. 7 is a block diagram showing a modification to the apparatus and method depicted in FIG. 5.

FIG. 8 is a flow diagram depicting the sequence of operation of the aspect of the tractor-trailer identification apparatus and order of hook-up shown in FIG. 1;

FIG. 9 is a flow diagram depicting another aspect of the sequence of operation of the tractor-trailer identification and order of hook-up apparatus and method shown in FIG. 1;

FIG. 10 is a flow diagram depicting the sequence of operation of the aspect of the tractor-trailer identification apparatus and order of hook-up shown in FIG. 4; and

FIG. 11 is a flow diagram depicting the sequence of operation of the aspect of the tractor-trailer identification apparatus shown in FIG. 5.

### DETAILED DESCRIPTION

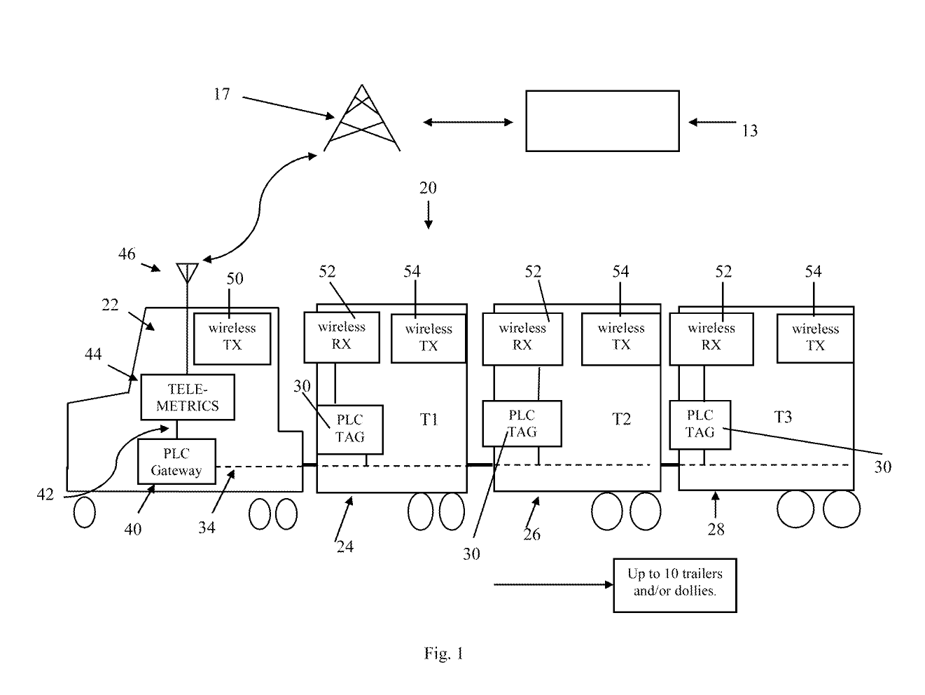

Referring now to the drawing and to FIGS. 1, 2 and 8 in particular, there is depicted one aspect of the tractor-trailer data communication apparatus 20 and method for determining the identification entity of and the order of hook-up of a tractor and the plurality of serially or tandem connected trailers. For example, as shown in FIG. 1, a tractor 22 has a plurality with three trailers 24, 26 and 28 shown by way of example only, connected serially or in tandem to the tractor 22. It will be understood that the trailer 24 is usually directly connected to the tractor 22; while trailers 26 and 28 ride on dollies connected to the rear end of the proceeding trailer 24 or 26.

In the trucking industry, the tractor 22 is electrically connected to the trailer 24 and the trailers 24, 26 and 28 are connected to each other by seven conductor umbilical cords connecting the electrical systems of tractor 22 to the electrical systems of the trailers 24, 26 and 28 to control trailer lighting, brake lights, braking, etc.

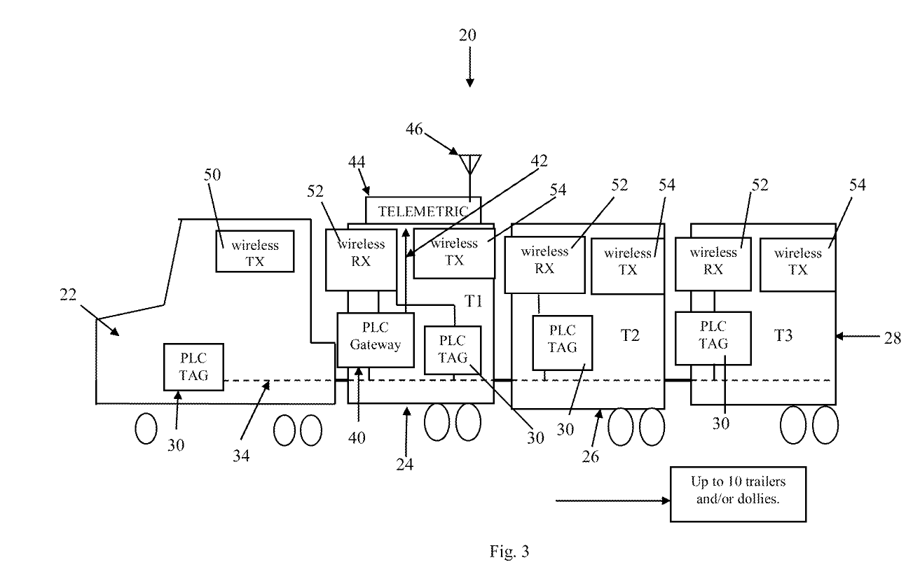

Due to the introduction of additional electronic systems in trailers, such as ABS brake controllers, tire air pressure monitor systems and refer temperature controls, a power line carrier (PLC) system is used to bi-directionally transmit signals along one of the conductors of the PLC system between the tractor 22 and the trailers 24, 26, and 28. As shown in FIGS. 1 and 3, the PLC system 34 is shown extending in signal communication from the tractor 22 through each of the trailers 24, 26 and 28.

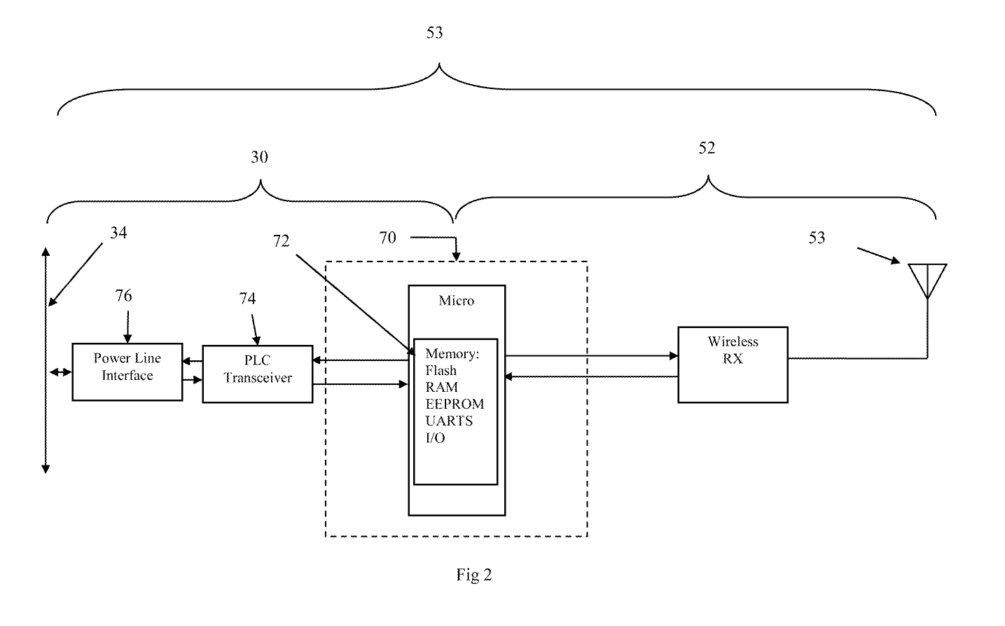

In the first aspect shown in FIGS. 1 and 2, the apparatus 20 includes the following hardware on the tractor 22 and each trailer 24, 26 and 28. The PLC system 34 includes a PLC Gateway or reader 40 in the form of a data communication terminal, as well as a PLC bus 34 which includes at least one of the conductors in the umbilical cords connecting the tractor 22 to the trailer 24 and the trailers 24, 26 and 28 to each other.

The tractor 22 carries a wireless transmitter 50 which is capable of transmitting via radio frequency communications typically at a designated frequency, over a short range sufficient to reach the forward or front end of the next adjacent trailer 24 in the tandem series of trailers 24, 26 and 28. The wireless transmitter 50 may have a range of approximately 10 feet so that the signal transmitted by the transmitter 50 is receivable by an appropriately tuned receiver only within the 10-foot distance.

A PLC Gateway 40 also referred to as a PLC Gateway reader 40, is illustrated in the first aspect as being mounted in the tractor 22. It will be understood that the PLC Gateway 40 may be mounted in either the tractor 22 or any of the trailers 24, 26 and 28, as described in subsequent aspects.

The PLC gateway 40 can also be a PLC CAN gateway sold by Hegemon Electronics, Inc. The gateway 40 provides a gateway for CAN, RS232, J1708 or J1939 equipped devices to get access to the PLC messages that reside on the tractor and trailer power lines 34. The PLC gateway 40 thus acts as an interface between the telemetrics unit 44 and the PLC tag 30 to bidirectionally relay messages from the PLC tag 30 to the telemetrics unit 44 and vice versa.

A telemetrics unit 44 is also mounted in the tractor 22 and provides communication between the tractor 22 and a remotely located central processing unit 13, which can be mounted at the headquarters of the trucking company.

The PLC gateway 40 typically communicates by hardwire conductors 42 to the telemetrics unit 44 using any OBC device using J1708, J1939, J1587, RS232, CanBus USB etc. As shown in FIG. 1, the telemetrics unit 44 communicates through an antenna 46 to a satellite, not shown, or to a cell tower 17 through the Internet and/or hardwired conductors to communicate the data from the PLC Gateway 40 to an external host computer remotely located processor 13. The telemetric unit 44 can also communicate with the external satellite and computer based host system through cellular, satellite, Wi-Fi, 802 etc., communications. The telemetrics unit 44 can also have tracking options such as GPS, RFID, RTLS, etc.

Telemetric units 44 are available from a number of companies, including, for example, Qualcomm, GE, International Telemetrics, RTL, Xata, Peoplenet, Skybitz, StarTrak, Partech, Cadec, FleetMind, Turnpike, Navman, etc.

Each trailer 24, 26 and 28 includes a wireless receiver 52 tuned to the frequency of the transmitters 50, 54. The receiver 52 is mounted on the forward end of the front nose of each trailer.

A wireless transmitter 54 is also mounted on each trailer 24, 26 and 28, generally adjacent the rear end of each trailer 24, 26 and 28 and coupled to an antenna 55.

A PLC tag 30 is also mounted on each trailer 24 in data communication with the PLC bus 34. The PLC tag 30 may be a PLC identifier tag manufactured by Hegemon Electronics, Inc., Sterling Heights, Mich. The PLC tag 30 functions as a reader to read data from the memory 72 of the PLC tag 30 and transforms the data into a format capable of communication over the existing tractor-trailer PLC bus 34. The PLC tag 30 includes a processor 70 which accesses data and a control program stored in one or more memories 72. The PLC tag 30 includes input and output ports namely, UART, I²C, or SPI.

The PLC tag processor 70 communicates through a PLC transceiver 74 and a power line interface 76 to bidirectionally receive and transmit data from the PLC tag 30 over the existing PLC bus lines 34 to the PLC gateway or reader 40 mounted in the tractor 10.

During the installation of the communication system 20 on the tractor 22 and the trailers 24, 26 and 28, the tractor 22 and each trailer 24, 26 and 28 will be provided with at least one unique identification number or identification. Each identification is unique to each trailer or a tractor and can include a particular identification identifying it as a tractor or a trailer. For example, the identification may include an alphanumeric segment identifying a particular tractor and trailer. A prefix, suffix, or a segment of the message may also include a binary code identifying the particular identification as uniquely belonging to a tractor or a trailer.

Alternately, the identifications assigned to tractors may be of a particular class to readily identify identification as belonging to a tractor or a trailer and to differentiate such tractor identifications from the trailer identifications, which are part of a different alphanumeric class.

A wireless identification is stored in the tractor transmitter 50 and each wireless transmitter 54 on the trailers 24, 26 and 28. Similarly, a PLC identification is stored in the PLC tag 30, such as in a memory 72. Both the wireless identification and the PLC identification may be the same for a tractor or trailer.

The wireless receiver identification and the PLC identification may be manually programmed into the memory of the wireless receiver 50 or 54 and into the memory 72 of the PLC tag 30 during the installation of the software into the processor in each wireless receiver 50, 54 or PLC tag 30.

Alternately, the wireless identification and the PLC identification may be installed in each tractor 22 and each trailer 24, 26 and 28 via data communication from the remote central processor 13 through the telemetrics unit 44. The remote control station 13 can initiate the programming by issuing an ID programming command. The command will contain the address of the component to be programmed and the new ID. The remote station 13 sends the command out to the network 17 and then onto the vehicle 22. The telemetrics device 44 in vehicle 22 picks up the command and passes it onto the PLC gateway 40. The PLC Gateway 40 then puts the information on the PLC Bus 34 and all PLC Tags 30 pick up the information. Only the addressed PLC Tag 30 accepts the information. All the rest of the PLC tags 30 reject the information. For example, PLC Tag 30 in trailer 24 is addressed and accepts the information. PLC Tag 30 in trailer 24 looks at the information. If the ID is for trailer 24, the PLC tag 30 then erases its old ID and then saves the new ID in non-violate memory. If the new ID is intended for the wireless TX 54 on trailer 24, the TX 54 is coupled to the PLC tag 30 then the PLC tag 30 passes the new ID onto the wireless TX 54 along with a new ID command. This will also work if the PLC gateway is installed in a trailer, such as in FIG. 3.

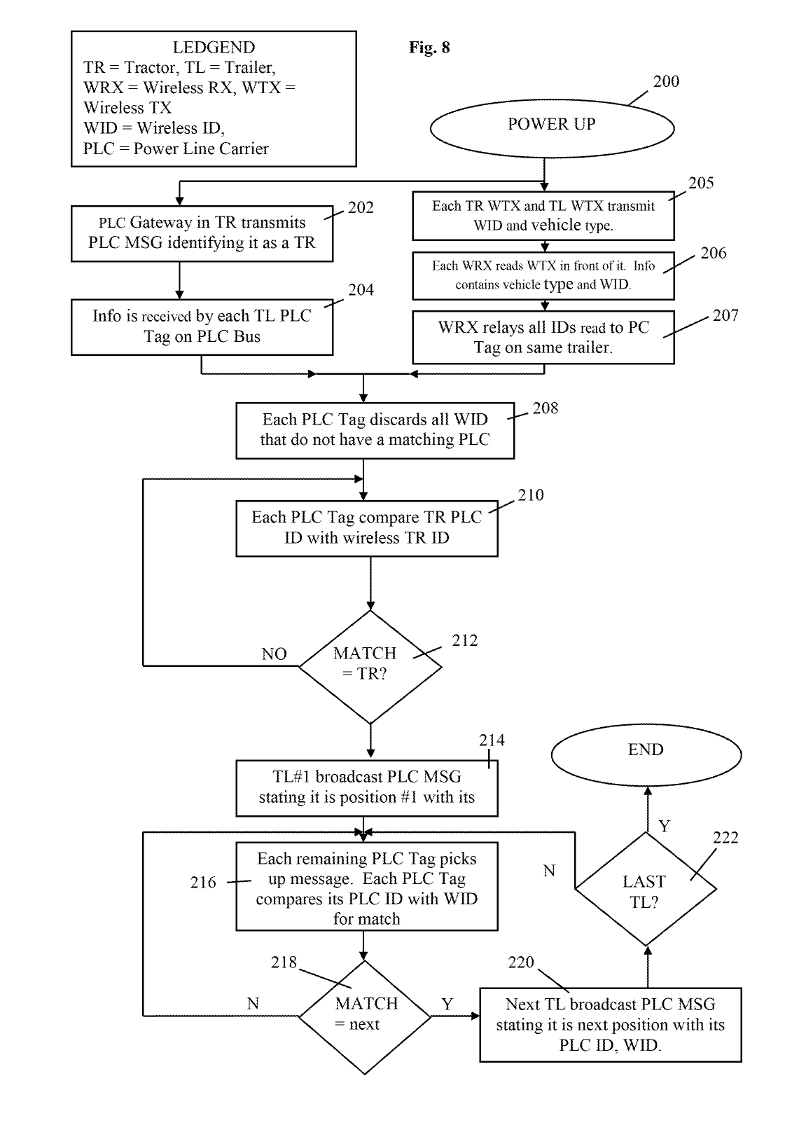

The operation of one aspect of the communication system will now be described in conjunction with FIGS. 1 and 2 and the flowchart shown in FIG. 8.

At power up (ignition on or continuously), step 200, the PLC Gateway 40 will transmit in step 202 a PLC message on the PLC bus 34, which will contain information identifying it as a tractor and the PLC identification. Each PLC Tag 30 in the trailers 24, 26 and 28 will receive this information over the PLC Bus in step 204 but, at this time the PLC tags 30 do not know which trailer 24, 26, 28 is connected to the tractor 22 or the order of the trailer hook-up.

Also at power up, each transmitter 50, 54 will transmit in step 205 a wireless message containing the wireless identification and the vehicle type either, tractor or trailer. Each wireless RX 52 will read the wireless message in step 206 from the transmitter 50, 54 in front of it. This wireless message will contain what vehicle the message was received from (tractor or trailer) and its wireless identification. It should be noted here that each wireless RX 52 may read more than one identification due to other vehicles being in close proximity and powered. After reception, the wireless RX 52 will relay all identifications it has read to the PLC Tag 30 on the same trailer 24, 26, 28 in step 207.

At this point all PLC Tags 30 know all the devices that are attached to the PLC bus 34, where they came from (tractor or a trailer), the PLC identification, and all wireless identifications read by its wireless RX 52. Each PLC Tag 30 will now, in step 208 sort through all the wireless identifications it has received and throw out the wireless identifications that do not have a corresponding PLC identification. This will eliminate all trailers that are not attached to the tractor 22.

Next each PLC Tag 30 in step 210 will look at the remaining wireless identifications and for a match in step 212 between the tractor PLC identification and the wireless tractor identification. Only one Tag will have a match because the wireless transmitters 50 is not powerful enough to reach the second, third, trailers 26, 28. The PLC Tag 30 that has received the wireless tractor identification is connected right behind the tractor 22 and therefore is trailer #1 in the lineup.

At this time trailer 24 knows it is hooked up right behind the tractor 22 so it now broadcasts a PLC message in step 214 stating that it is the #1 trailer in the tandem trailer sequence. This message will contain its PLC identification, its wireless identification, and its position, in this case trailer #1. The PLC tags 30 in trailers 26 and 28 pick up this message. The tractor 22 ignores this message. Trailer 26 and trailer 28 now compare in step 216 this wireless identification with the wireless identification they received from their wireless receiver. A match in step 218 will mean the next trailer #2 in the hook-up sequence is trailer 26.

The process is now repeated. Trailer 26 transmits a PLC message, in step 220 containing its PLC identification, its wireless identification, and its hook-up position (#2). The tractor 22 and trailer 24 ignore this message. Trailer 28 uses this information to figure out it is trailer #3. This process is repeated until all trailers have established their placement in step 222.

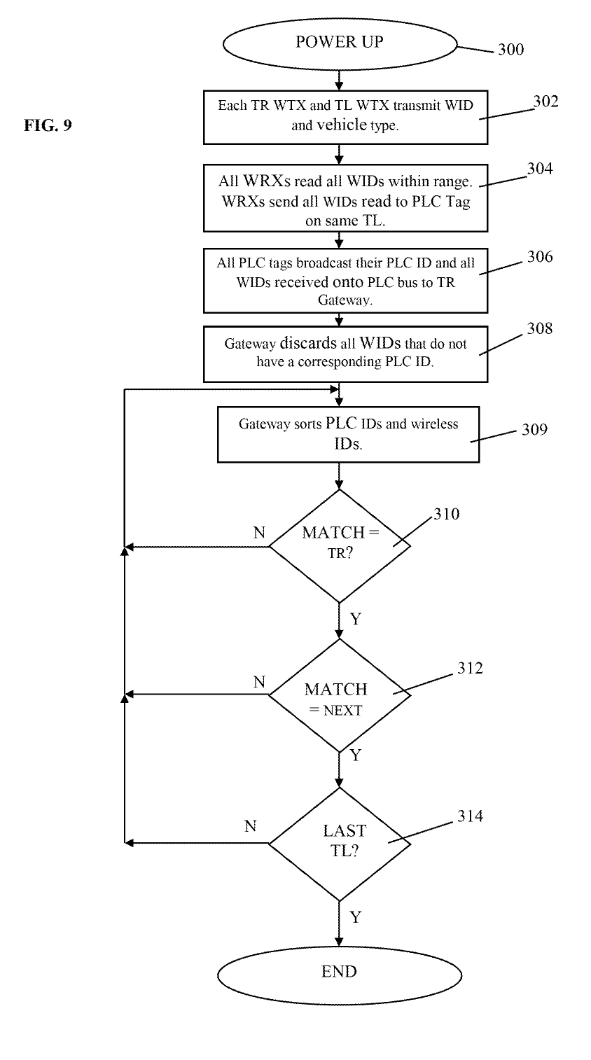

An alternate method for determining the tractor 22 and trailers 24, 26, 28 identification and the order of hook-up of the trailers 24, 26 and 28 to the tractor 22 is shown in FIG. 9.

This method has the same hardware configuration shown in FIG. 1. The difference between the first method and this method is that all decision making with respect to determining the hook-up order of the trailers 24, 26 and 28 to the tractor 22 is done in the PLC gateway 40.

On power up, step 300, all transmitters 50 and 54 transmit the wireless identification and vehicle type information to broadcast all of the respective wireless identification vehicle type. All wireless receivers 52 read all wireless identifications that are within range including the wireless TX 50, 54 in front of it in step 304. Such wirelesses RXs 52 send all wireless of the identifications it has read to its PLC tag 30 in step 304. The PLC tags 30 broadcast this information onto the PLC bus 34 in step 306. The tractor PLC Gateway 40 picks up all of these PLC broadcasts with wireless information and now knows who is connected to the tractor but does not know the order.

Also power up step 300, all PLC Tags 30 broadcast their PLC identification onto the PLC bus 34 in step 306.

The PLC Gateway 40 then sorts in step 309 through all the wireless identifications it has received in and throws out all the wireless identifications that do not have a corresponding PLC identification that was received in steps 304 and 306. This removes all unconnected vehicles from the database.

The PLC Gateway 40 now knows the wireless and PLC identification for each trailer. PLC Gateway 40 in step 309 now sorts through the data in step 309 and looks for the PLC tag 30 that reported that it saw the tractor 22 wireless identification in step 310. The Gateway 40 now knows that trailer 24 is trailer #1.

The PLC Gateway 40 now repeats step 309 and sorts through the data and finds the PLC Tag 30 who read the wireless identification from the trailer #1. It now knows which the second trailer 26 is.

Step 309 is repeated by the PLC Gateway 40 until all trailers have been ordered per step 314.

The PLC Tag 30 and the wireless receiver 52 on each trailer 24, 26 and 28 can be combined into one module 53 for cost reductions.

The wireless transmitters 50, 54 and the wireless receivers 52 utilize ultrasonic, low frequency radio waves, or medium frequency radio waves or Bluetooth.

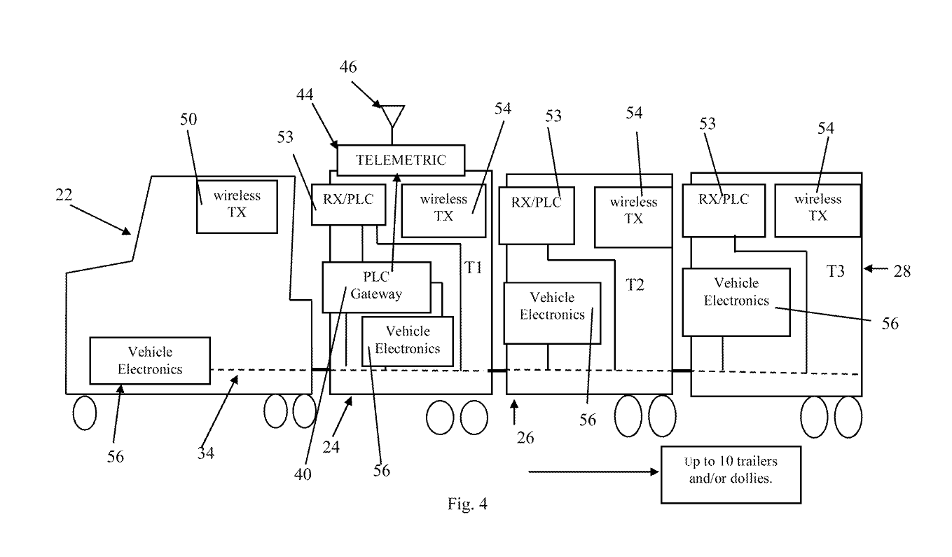

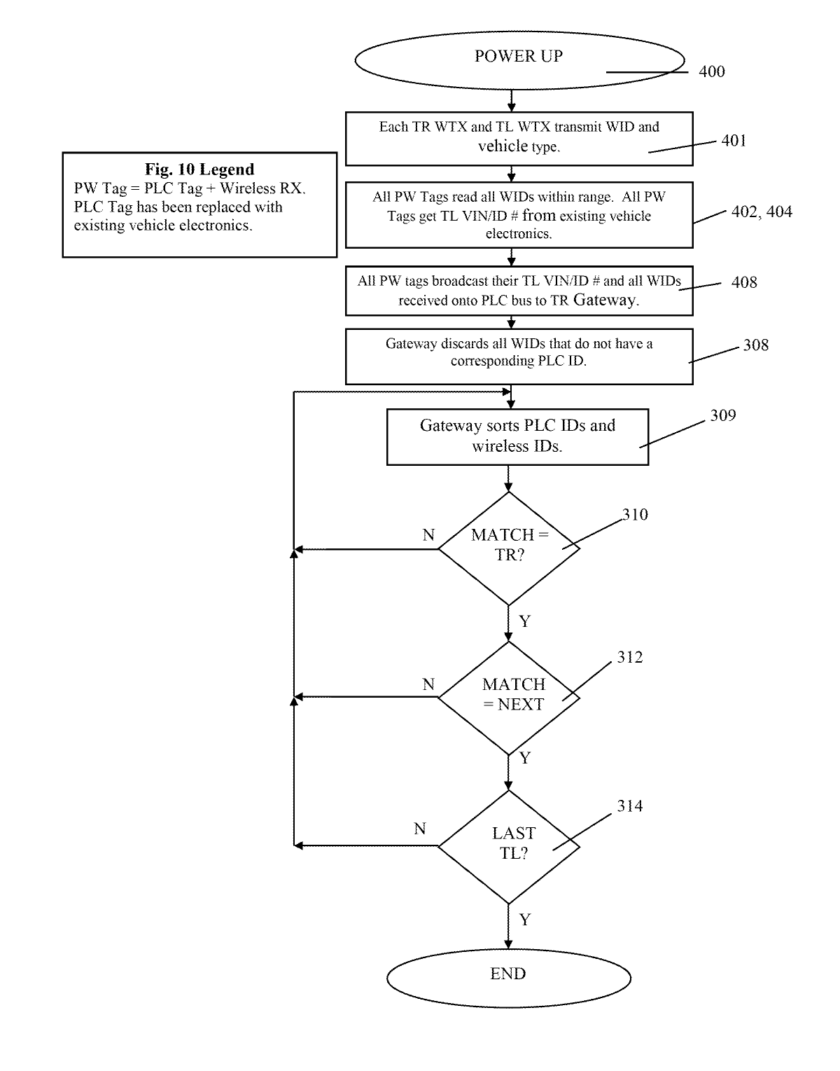

Referring now to FIGS. 4 and 10, another aspect of the communication apparatus and method will be described. This method is a low cost solution to accomplish the above described methods by using existing electronic modules 56 on the tractor 22 and the trailers 24, 26 and 28. This apparatus includes the same hardware as shown in FIGS. 1-3, except that the PLC portion of each PLC tag 30 is incorporated into one wireless receiver as module 53 as shown in FIG. 2.

A unique vehicle identification, such as the vehicle's VIN (Vehicle Identification Number) or other number uniquely identifying the vehicle, is read directly from factory installed electronic modules 56 on each trailer 24, 26 and 28, as well as on the tractor 22. Examples of existing electronic modules which can communicate through the PLC bus 34 to the PLC Gateway 40 include, but are not limited to the trailer or tractor ABS controller, the trailer or tractor tire air pressure system, and the trailer refer temperature controller. In the following description of the control sequence used in this method, as shown in FIG. 10, the vehicle electronics will be referred to as the ABS controllers 56, for example.

Upon power up, all wireless transmitters 50 and 54 transmit a wireless identification and vehicle type. All wireless receivers 53 read in step 402 all wireless identifications that are within range including the wireless TX 50 or 54 in front of it. The wireless RXs 53 broadcast all wireless identifications read and the VIN number onto the PLC Bus 34 in step 408. The tractor PLC Gateway 40 picks up all of these PLC broadcasts and wireless information.

At install, the wireless RX/PLC module 53 is programmed with vehicle's VIN number. This can be done in a variety of ways ranging from automatic to human programming. This can be a one-time event.

Also on power up (ignition on or continuously), step 400, FIG. 10, the PLC tags 53 interrogates their respective vehicle electronic modules 56 for the vehicle VIN number in step 402.

Upon power up in step 400, all wireless receivers 53 read in step 402 all wireless identifications that are within range including the wireless TX 50 or 54 in front of it. The wireless RXs 53 broadcast all wireless IDs read and the VIN onto the PLC bus 34 in step 408. The tractor PLC Gateway 40 picks up all of these PLC broadcasts and wireless information.

The PLC Gateway 40 then repeats steps 309-314 of the method shown in FIG. 9 as follows. The PLC Gateway 40 then sorts through all the wireless identifications it received in step 309 and throws out all the wireless identifications that do not have a corresponding PLC identification that was received in step 402. This removes all unconnected vehicles from the database.

The PLC Gateway 40 now knows the wireless identification and VIN number for each trailer 24, 26, and 28. It now sorts through the data and looks for the RX/PLC module 53 that reported that it saw the tractor 22 wireless identification. The PLC Gateway 40 now knows which is the first trailer in the hook-up order to the tractor 22.

The PLC Gateway 40 now sorts through the data and finds the RX/PLC tag 53 who read the wireless identification from the first trailer 24. It knows which is the second trailer 26 in the hook-up order.

Step 309 is repeated until all trailers have been ordered in step 314.

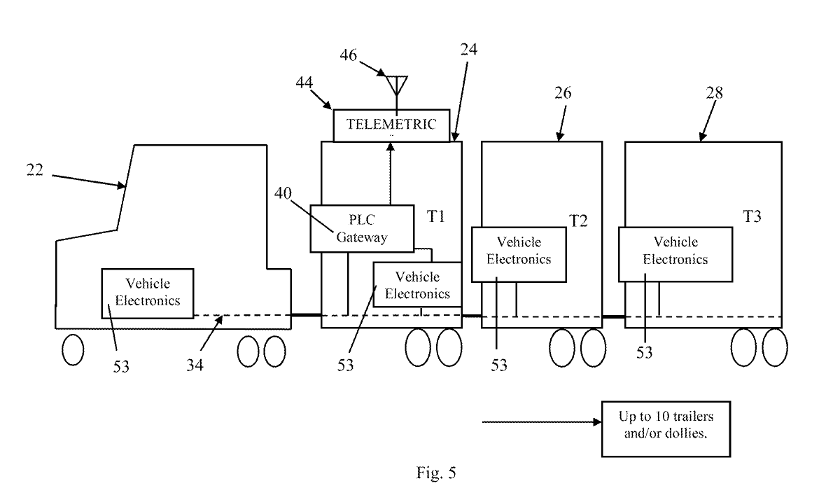

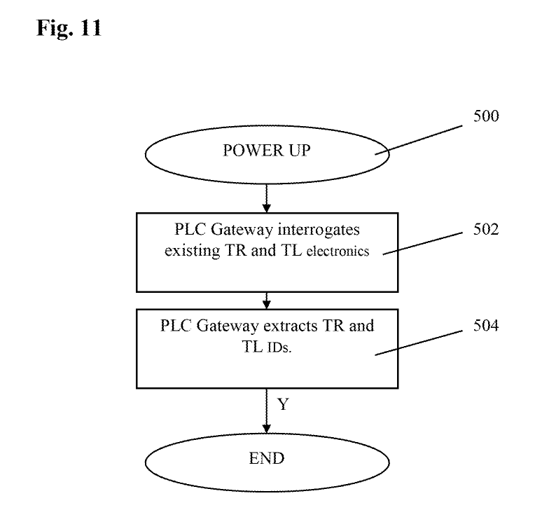

Referring now to FIGS. 5 and 11, there is depicted another aspect of a communication apparatus and method which can also be used as a very low cost vehicle tractor-trailer identification system. To be a low cost vehicle identification system, the wireless devices 50, 52 and 54 installed on the trailers 22, 24, and 26 are not required.

To identify all trailers and the tractor by their unique identification, the only new module required is the PLC Gateway 40 which is mounted on one of the trailers 24, 26 or 28. Upon power up step 500, FIG. 11 the PLC Gateway 40 will extract the VIN numbers, or other identification, out of each trailer's and tractor's existing vehicle electronic box in step 502, 504. The only new component required for purchase by the customer is the PLC Gateway 40.

It should be noted that although FIG. 5 shows the PLC Gateway 40 as being located on the trailer 24, the PLC Gateway 40 can alternately be mounted on the tractor 22 on any of the trailers 24, 26 and 28. Regardless of the mounting location, the PLC Gateway 40 is uniquely capable of extracting and reading the VIN numbers or other tractor or trailer identifications from any of the serially connected tractor 22 and trailers 24, 26 and 28.

Generally, the PLC Gateway 40 is located close to and usually in the same vehicle as the GPS tracking system used to track the particular vehicle, whether it is the tractor 22 or the trailers 24, 26 and 28.

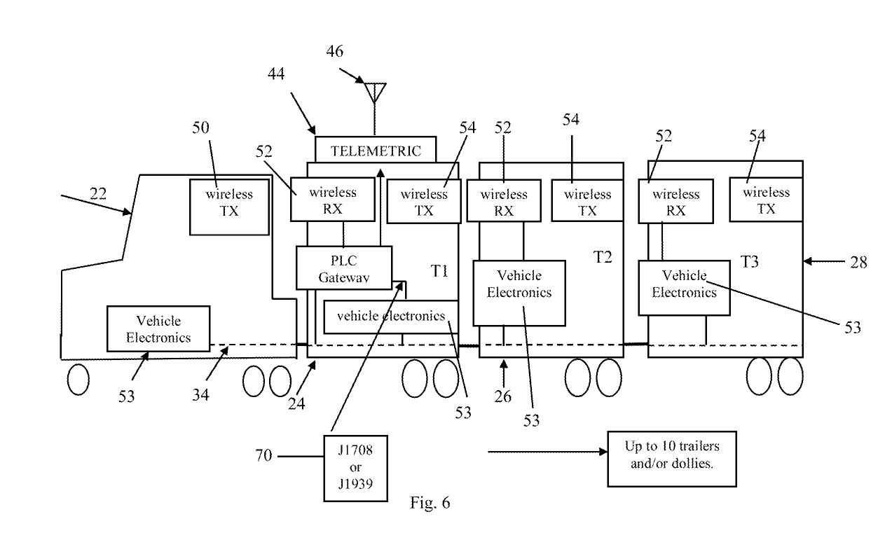

Referring now to FIG. 6, there is depicted a modification to the apparatus shown in FIG. 4. A J1708 and/or a J1939 port can be added to the PLC gateway 40. The J1708 and/or J1939 port enables all information that is not available through the PLC port to the telemetrics 44, but is obtainable through the J1708 and/or J1939 port, to be supplied to the telemetrics device 44 for off-trailer transmission to the remote processor 13. For example, such information may include trailer mileage, tractor mileage, etc.

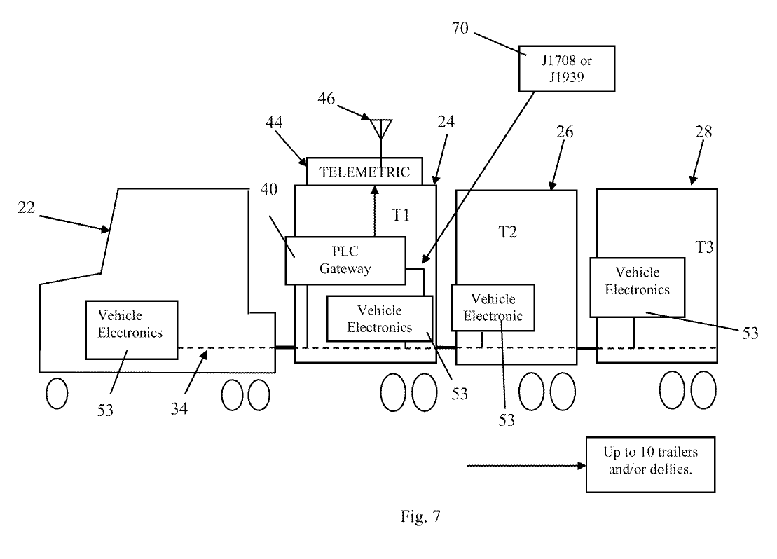

FIG. 7 depicts the same addition of a J1709 and/or a J1939 port to the PLC Gateway 40 in the apparatus shown in FIG. 7 where the PLC Gateway 40 is programmed to extract the trailer or tractor identifications from the respective vehicle electronics 53.

It should be also noted that all of the information that is available on the PLC bus 34 is supplied to the PLC Gateway 40 and can be transmitted off-trailer to the remotely located processor 13. Such information can include the trailer and tractor mileages, the ABS status, the tire pressure, door status, either opened or closed, and trailer temperature can also be provided for any or all of the tractor and the trailers.

What is claimed is:

1. A method for use with a plurality of trailers, each having a unique
trailer identification, sequentially coupled to a tractor having a unique tractor identification comprising:
coupling the tractor and each of the plurality of trailers in data communication via a power line carrier system; and
identifying the unique trailer identification in the order of coupling of each trailer to the tractor using, part, the power line carrier system.

2. The method of claim 1 further comprising:
coupling a power line carrier system to at least one power conductor coupled between a tractor and each of the plurality of trailers for communicating data signals over the at least one power conductor between the tractor and each of the plurality of trailers.

3. The method of claim 1 wherein the step of identifying the trailer
identification comprises:
providing a unique power line carrier identification in each of the tractor and the plurality of trailers.

4. The method of claim 3 wherein the step of providing the power
line carrier identification comprises:
providing an identification tag on each trailer configured to broadcast unique power line carrier trailer identification from each trailer to the power line carrier system.

5. The method of claim 4 further comprising:
providing a wireless transmitter on each of the tractor and the plurality of trailers, each transmitter transmitting a message containing a unique wireless identification and an indication of the vehicle type;
providing a wireless transmitter on each of the plurality of trailers coupled to the power line carrier system through the identification tag; and
each wireless receiver communicating the identification in the tractor and the plurality of trailers messages received from at least one transmitter to the power line carrier system via the identification tag.

6. A method to identify the order of a plurality of trailers serially
coupled to a tractor comprising;
coupling a power line carrier system including at least one power conductor coupled between a tractor and each of the plurality of trailers for communicating data signals over the at least one power conductor between the tractor and each of the plurality of trailers;
coupling a power line carrier gateway in one of the tractor and the plurality of trailers to the power line carrier system;
mounting a wireless transmitter in the tractor;
mounting a wireless receiver and a wireless transmitter in each of the plurality of trailers, each transmitter in each trailer containing a unique wireless trailer identification;
providing a unique power line carrier trailer tag on each of the plurality of trailers, each tag including a power line carrier identification;
transmitting by the power line carrier gateway a message on the power line carrier system containing information identifying the message as coming from the tractor and including the tractor identification;
receiving by the power line carrier tag on each of the plurality of trailers the message from the power line carrier gateway;
transmitting by the wireless transmitter on each of the plurality of trailers the trailer identification to all of the trailers and the tractor within a signal range of the transmitter;
the wireless receiver receiving the message from the transmitters and communicating the vehicle type and identification to the power line carrier tag;
determining a match by one power line carrier tag between the wireless tractor identification and the power line carrier tractor identification received by only one of the plurality of trailers to identify the first trailer coupled to the tractor;
transmitting by the first identified trailer a signal on the power line carrier system that it is the first trailer coupled to the tractor; and
receiving by each of the remaining plurality of trailers the signal from the first trailer and comparing the identification of the first trailer with the identification received by the wireless receiver on each other trailer and determining a match, the match identifying the second trailer coupled to the first trailer.

7. The method of claim 6 further comprising:
storing each tractor and trailer identification in a readable power line carrier tag mounted respectively on each tractor and trailer and coupled to the power line carrier system.

8. The method of claim 7 further comprising:
wirelessly transmitting by the trailers each identification on the power line carrier system;
receiving the trailer identification by the power line carrier gateway;
receiving by each wireless receiver on each trailer wireless identification broadcasts by the transmitters on others of the plurality of trailers;
transmitting by each trailer wireless receivers all of the received trailer identifications onto the power line carrier system through the power line carrier identification tag;
receiving by the power line carrier gateway all of the trailer identifications and determining a match with the identifications received from the initial trailer identification broadcast;
comparing by the power line carrier gateway the trailer identification data to determine the trailer identification that reported the tractor identification to identify the trailer coupled to the tractor; and
for each remaining one of the plurality of trailers, the power line carrier gateway determining a match between the identification on the power line carrier tag on trailer which read the trailer identification from the proceeding trailer.

9. The method of claim 8 wherein:
each transmitter on each of the trailers having an effective transmission range to reach only a distance to a front portion of the next adjacent serially connected trailer.

10. The method of claim 6 further comprising:
remotely programming at least one of a tractor wireless ID, a tractor wireless identification, a trailer wireless identification, a tractor power line carrier identification and a trailer power line carrier identification from the remote processor.

11. A method to identify a tractor and one or more trailers serially
coupled to the tractor comprising;
a power line carrier system coupled to at least one power conductor coupled between a tractor and each of the plurality of trailers for communicating data signals over the at least one power conductor between the tractor and each of the plurality of trailers;
mounting a power line carrier gateway in one of the plurality of trailers and coupled to the power line carrier system;
storing a readable vehicle identification in an electronic control module in each of the tractor and each of the plurality of the trailers; and
the power line carrier gateway extracting the vehicle identification from each of the tractor and the trailer electronic modules via the power line carrier system, to identify the serially connected tractor and the plurality of trailers.

12. The method of claim 11 wherein:
the power line carrier gateway extracting the vehicle identification from the electronic control module in the tractor via the power line carrier system to identify the particular tractor coupled to the trailer carrying the power line carrier gateway.

13. The method of claim 11 wherein:
the electronic module mounted on each trailer and each of the plurality of tractors comprises one of an ABS controller, a tire air pressure apparatus and a trailer temperature controller.

14. The method of claim 11 further comprising:
mounting a wireless transmitter in the tractor containing a tractor identification;
mounting a wireless receiver and a wireless transmitter in each of the plurality of trailers, each transmitter in each trailer containing a unique wireless trailer identification;
transmitting by the wireless transmitter on the tractor and each of the plurality of trailers the identification to all of the trailers and the tractor within a signal range of the transmitter;
the wireless receivers receiving the message from the transmitters and communicating the vehicle type and identification to the power line carrier tag;
receiving by the power line carrier gateway all of the trailer identifications and determining a match with the identifications received from the initial trailer identification broadcast;
comparing by the power line carrier gateway the trailer identification data to determine the trailer identification that reported the tractor identification to identify the trailer coupled to the tractor;
transmitting by the first identified trailer a signal on the power line carrier system that it is the first trailer coupled to the tractor; and
for each remaining one of the plurality of trailers, the power line carrier gateway determining a match between the identification on the power line carrier tag on trailer which read the trailer identification from the proceeding trailer.

15. The method of claim 11 further comprising;
a communication port coupled between the power line carrier data terminal and the at least one electronic control module for communicating data from the electronic control module to a telemetrics unit mounted on one of the plurality of trailers.

16. The method of claim 15 wherein:
a communication port is one of a J1708 and J1939 port.
